(19) United States
(12) Patent Application Publication
(10) Pub. No.: US 2024/0098484 A1
(43) Pub. Date: Mar. 21, 2024

(54) MODEL GENERALIZATION

(71) Applicant: QUALCOMM Incorporated, San Diego, CA (US)

(72) Inventors: Rajeev KUMAR, San Diego, CA (US); Aziz GHOLMIEH, Del Mar, CA (US)

(21) Appl. No.: 18/331,718

(22) Filed: Jun. 8, 2023

Related U.S. Application Data
(60) Provisional application No. 63/376,566, filed on Sep. 21, 2022.

(51) Int. Cl. H04W 8/24; H04W 36/36; H04W 76/10

(52) U.S. Cl. CPC H04W 8/24; H04W 36/36; H04W 76/10; H04W 84/042

(57) ABSTRACT

Various aspects of the present disclosure generally relate to wireless communication. In some aspects, a user equipment (UE) may obtain generalization information associated with a model, a model structure (MS), or a parameter set (PS) associated with the model. The UE may initiate a connection to a network node. The UE may filter the model, the MS, or the PS based at least in part on the generalization information. The UE may transmit UE capability information to the network node, based at least in part on filtering the model, the MS or the PS, that indicates whether the model, the MS, or the PS is applicable, available, or supported by the UE. Numerous other aspects are described.

### CROSS-REFERENCE TO RELATED APPLICATION

This Patent application claims priority to U.S. Provisional Patent Application No. 63/376,566, filed on Sep. 21, 2022, entitled “MODEL GENERALIZATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for model generalization.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include obtaining generalization information associated with a model, a model structure (MS), or a parameter set (PS) associated with the model. The method may include initiating a connection to a network node. The method may include filtering the model, the MS, or the PS based at least in part on the generalization information. The method may include transmitting UE capability information to the network node, based at least in part on filtering the model, the MS or the PS, that indicates whether the model, the MS, or the PS is applicable, available, or supported by the UE.

Some aspects described herein relate to a method of wireless communication performed by a network node. The method may include obtaining generalization information associated with a model, an MS, or a PS associated with the model. The method may include receiving UE capability information associated with a UE. The method may include filtering the model, the MS, or the PS based at least in part on the generalization information and the UE capability information. The method may include transmitting an indication, to the UE, that indicates whether the model, the MS, or the PS is to be activated, deactivated, or switched by the UE.

Some aspects described herein relate to an apparatus for wireless communication performed by a UE. The apparatus may include a memory and one or more processors, coupled to the memory. The one or more processors may be configured to obtain generalization information associated with a model, an MS, or a PS associated with the model. The one or more processors may be configured to initiate a connection to a network node. The one or more processors may be configured to filter the model, the MS, or the PS based at least in part on the generalization information. The one or more processors may be configured to transmit UE capability information to the network node, based at least in part on filtering the model, the MS or the PS, that indicates whether the model, the MS, or the PS is applicable, available, or supported by the UE.

Some aspects described herein relate to an apparatus for wireless communication performed by a network node. The apparatus may include a memory and one or more processors, coupled to the memory. The one or more processors may be configured to obtain generalization information associated with a model, an MS, or a PS associated with the model. The one or more processors may be configured to receive UE capability information associated with a UE. The one or more processors may be configured to filter the model, the MS, or the PS based at least in part on the generalization information and the UE capability information. The one or more processors may be configured to transmit an indication, to the UE, that indicates whether the model, the MS, or the PS is to be activated, deactivated, or switched by the UE.

Some aspects described herein relate to a non-transitory computer-readable medium that stores a set of instructions for wireless communication by a UE. The set of instructions, when executed by one or more processors of the UE, may cause the UE to obtain generalization information associated with a model, an MS, or a PS associated with the model. The set of instructions, when executed by one or more processors of the UE, may cause the UE to initiate a connection to a network node. The set of instructions, when executed by one or more processors of the UE, may cause the UE to filter the model, the MS, or the PS based at least in part on the generalization information. The set of instructions, when executed by one or more processors of the UE, may cause the UE to transmit UE capability information to the network node, based at least in part on filtering the model, the MS or the PS, that indicates whether the model, the MS, or the PS is applicable, available, or supported by the UE.

Some aspects described herein relate to a non-transitory computer-readable medium that stores a set of instructions for wireless communication by a network node. The set of instructions, when executed by one or more processors of the network node, may cause the network node to obtain generalization information associated with a model, an MS, or a PS associated with the model. The set of instructions, when executed by one or more processors of the network node, may cause the network node to receive UE capability information associated with a UE. The set of instructions, when executed by one or more processors of the network node, may cause the network node to filter the model, the MS, or the PS based at least in part on the generalization information and the UE capability information. The set of instructions, when executed by one or more processors of the network node, may cause the network node to transmit an indication, to the UE, that indicates whether the model, the MS, or the PS is to be activated, deactivated, or switched by the UE.

Some aspects described herein relate to an apparatus for wireless communication. The apparatus may include means for obtaining generalization information associated with a model, an MS, or a PS associated with the model. The apparatus may include means for initiating a connection to a network node. The apparatus may include means for filtering the model, the MS, or the PS based at least in part on the generalization information. The apparatus may include means for transmitting UE capability information to the network node, based at least in part on filtering the model, the MS or the PS, that indicates whether the model, the MS, or the PS is applicable, available, or supported by the UE.

Some aspects described herein relate to an apparatus for wireless communication. The apparatus may include means for obtaining generalization information associated with a model, an MS, or a PS associated with the model. The apparatus may include means for receiving UE capability information associated with a UE. The apparatus may include means for filtering the model, the MS, or the PS based at least in part on the generalization information and the UE capability information. The apparatus may include means for transmitting an indication, to the UE, that indicates whether the model, the MS, or the PS is to be activated, deactivated, or switched by the UE.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of models for communication, in accordance with the present disclosure.

FIGS. 5A and 5B illustrate examples of model generalization, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

A model may be an artificial intelligence (AI) model or a machine learning (ML) model, and the model may be associated with a model structure (MS). In some cases, model or MS generalization may include applying a model or MS, that is designed for a first function, feature, or feature group, to one or more other functions, features, or feature groups that are different than the first function, feature, or feature group. Model or MS generalization may result in model performance degradation. For example, applying the model or MS that is designed for the first function to the one or more other functions may result in the model performing with decreased accuracy or efficiency. In some cases, generalization of the model or MS across numerous functions may use a large number of parameters. When a sufficient generalization is achieved for the model or MS at the cost of an increase in size of the model or MS, a user equipment (UE) may not be able to properly load or otherwise use the model. Thus, it may be beneficial to balance between the generalization for the model and the size of the model.

Various aspects relate generally to model generalization. In some aspects, a UE may obtain generalization information associated with a model. The UE may initiate a connection to a network node and may filter the model based at least in part on the generalization information. The UE may transmit UE capability information to the network node, based at least in part on filtering the model, that indicates whether the model is applicable, available at the UE, or supported by the UE. In some other aspects, the network node may obtain generalization information associated with the model. The network node may receive UE capability information associated with a UE and may filter the model based at least in part on the generalization information and the UE capability information. The network node may transmit an indication, to the UE, that indicates whether the model, the MS, or the PS is to be activated, deactivated, or switched by the UE, or that indicates whether the UE is to use legacy methods for one or more features or feature groups.

Particular aspects of the subject matter described in this disclosure can be implemented to realize one or more of the following potential advantages. A UE may filter a model and may transmit UE capability information to the network node that indicates whether the UE is configured to use the model. Additionally, or alternatively, the network node may filter the model and may transmit an indication that indicates whether the model, the MS, or the PS is to be activated, deactivated, or switched by the UE, or that indicates whether the UE is to use legacy methods for one or more features or feature groups. This may result in the UE being configured with a model that is generalized across one or more functions, features, or feature groups of the UE and that has a size that is capable of being loaded and otherwise used by the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

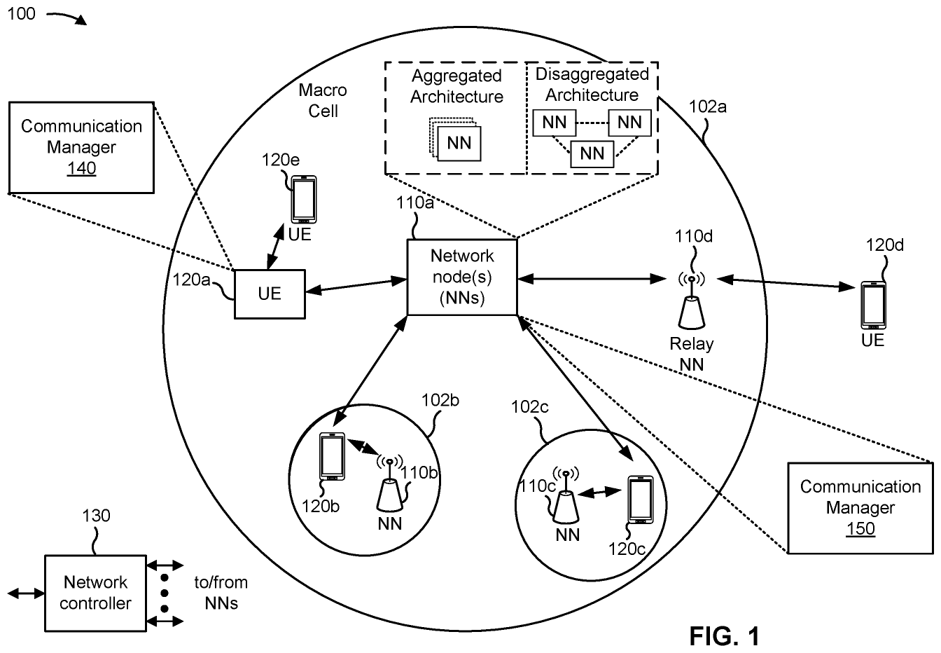

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may obtain generalization information associated with a model, a model structure (MS), or a parameter set (PS) associated with the model; initiate a connection to a network node; filter the model, the MS, or the PS based at least in part on the generalization information; and transmit UE capability information to the network node, based at least in part on filtering the model, the MS or the PS, that indicates whether the model, the MS, or the PS is applicable, available, or supported by the UE. Additionally, or alternatively, the communication manager 140 may perform one or more other operations described herein.

In some aspects, the network node 110 may include a communication manager 150. As described in more detail elsewhere herein, the communication manager 150 may obtain generalization information associated with a model, an MS, or a PS associated with the model; receive UE capability information associated with a UE; filter the model, the MS, or the PS based at least in part on the generalization information and the UE capability information; and transmit an indication, to the UE, that indicates whether the model, the MS, or the PS is to be activated, deactivated, or switched by the UE. Additionally, or alternatively, the communication manager 150 may perform one or more other operations described herein.

As indicated above, FIG. 1 is provided as an example. Other examples may differ from what is described with regard to FIG. 1.

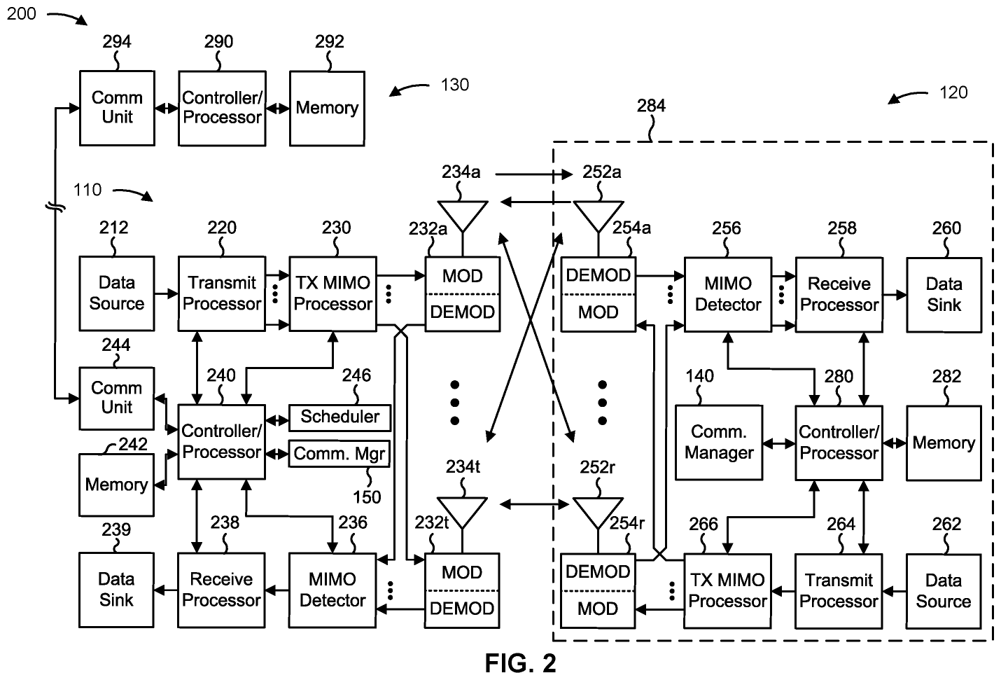

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

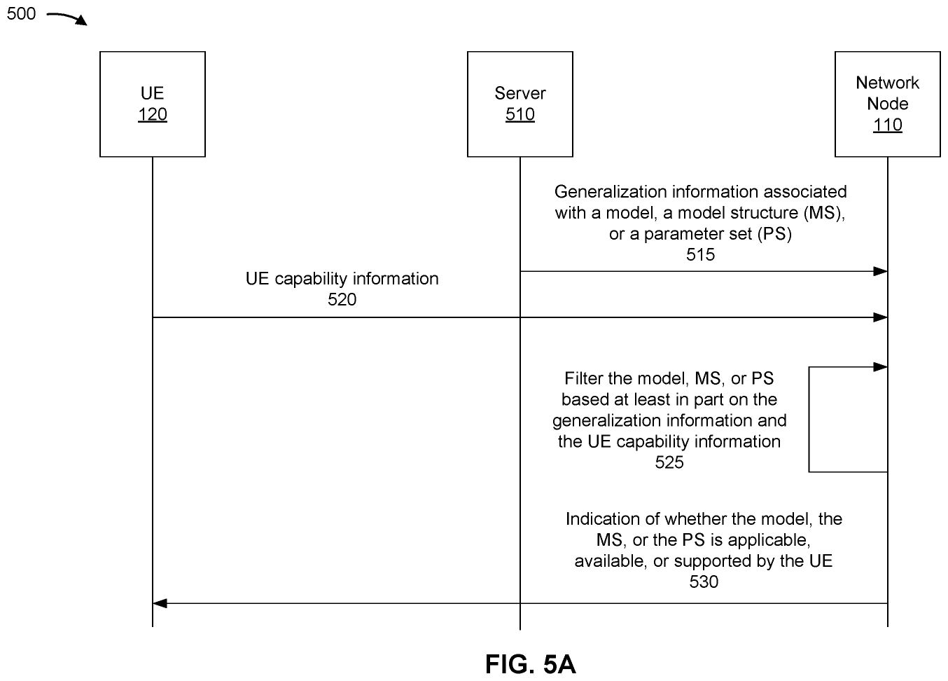

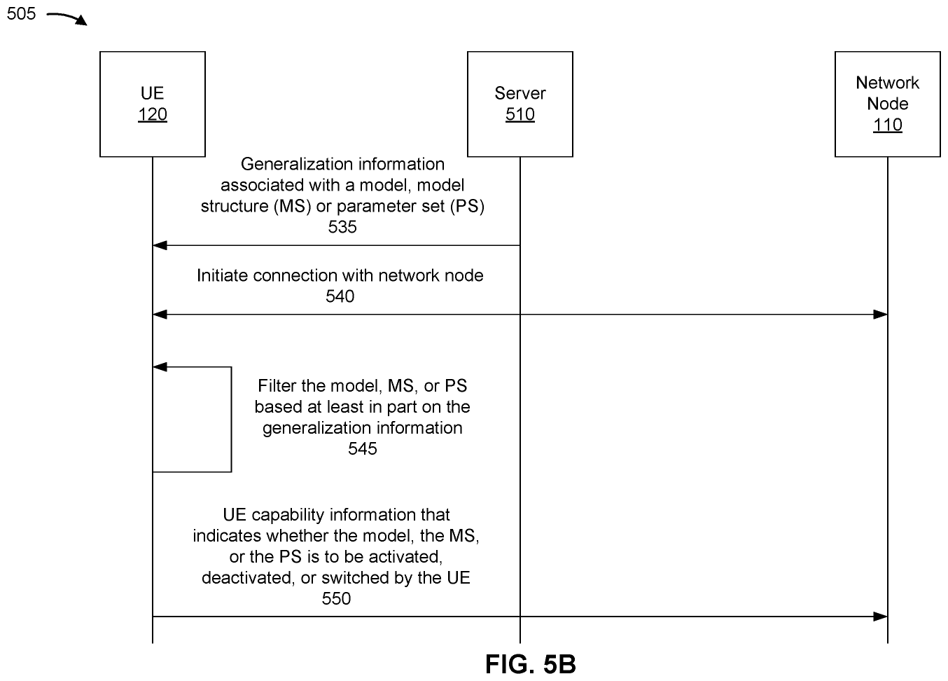

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A, 5B, 6, 7, 8, and 9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A, 5B, 6, 7, 8, and 9).

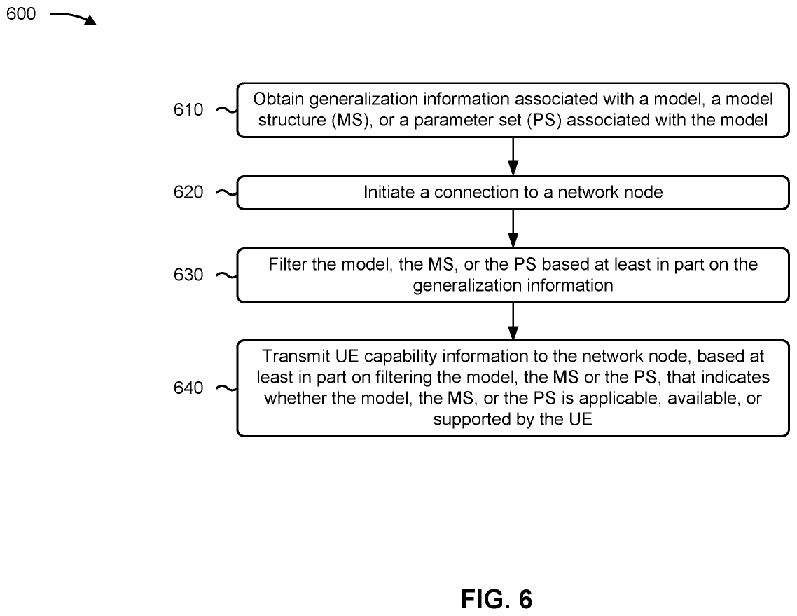

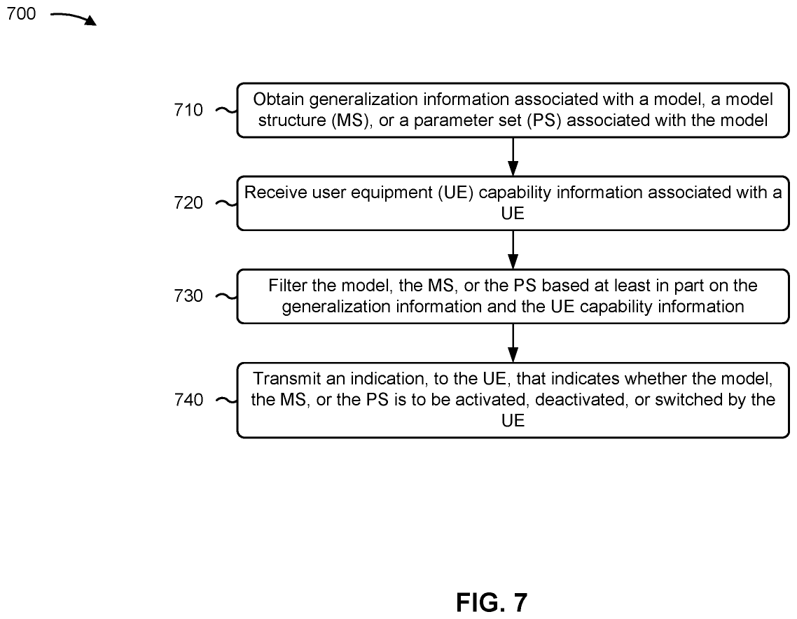

The controller/processor 240 of the network node 110, the controller/processor 280 of the UE 120, and/or any other component(s) of FIG. 2 may perform one or more techniques associated with model generalization, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for obtaining generalization information associated with a model, an MS, or a PS associated with the model; means for initiating a connection to a network node; means for filtering the model, the MS, or the PS based at least in part on the generalization information; and/or means for transmitting UE capability information to the network node, based at least in part on filtering the model, the MS or the PS, that indicates whether the model, the MS, or the PS is applicable, available, or supported by the UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for obtaining generalization information associated with a model, an MS, or a PS associated with the model; means for receiving UE capability information associated with a UE; means for filtering the model, the MS, or the PS based at least in part on the generalization information and the UE capability information; and/or means for transmitting an indication, to the UE, that indicates whether the model, the MS, or the PS is to be activated, deactivated, or switched by the UE. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

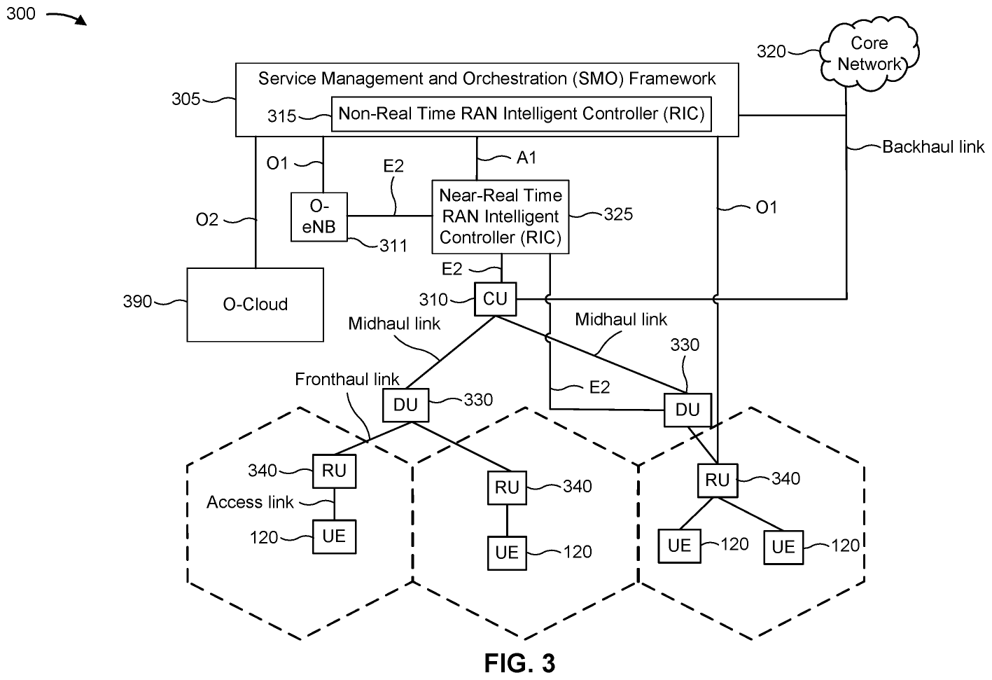

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

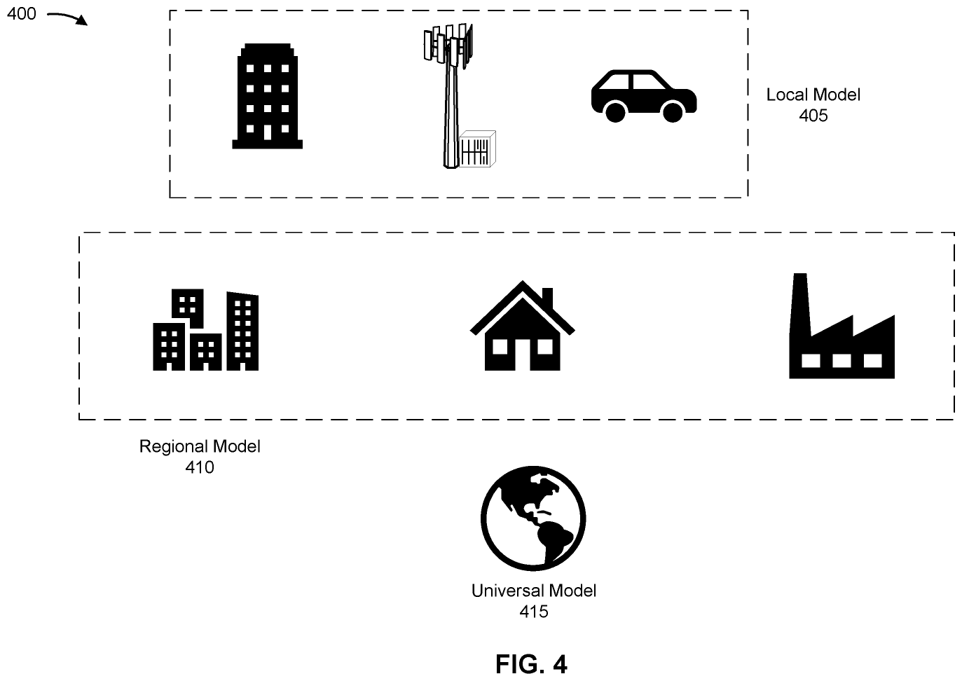

FIG. 4 is a diagram illustrating an example 400 of models for communication, in accordance with the present disclosure.

In some cases, a model may be an artificial intelligence (AI) model or a machine learning (ML) model, and the model may be associated with an MS. Model or MS generalization may result in model performance degradation. In some cases, model or MS generalization may include applying a model or MS, that is designed for a first function, feature, or feature group, to one or more other functions, features, or feature groups that are different than the first function, feature, or feature group. Applying the model or MS that is designed for the first function, feature, or feature group to the one or more other functions, features, or feature groups may result in the model performing with decreased accuracy or efficiency. In some cases, generalization of the model or MS across numerous functions, features, or feature groups may use a large number of parameters. When a sufficient generalization is achieved for the model or MS at the cost of an increase in size of the model or MS, the UE 120 may not be able to properly load or otherwise use the model. Thus, it may be beneficial to balance between the generalization for the model and the size of the model. For an AI or ML use case, such as for an AI feature, ML feature, or machine learning function name (MLFN), multiple models or model structures may be developed. In one example, for a set of AI or ML features, a model or MS may not be generalized outside of a specific cell area or band. For example, the model may only be applicable to the specific cell area or band. An example of this type of model is shown by local model 405. In another example, for a set of AI or ML features, a model or MS may be generalized in more than one area or band combination. For example, the model or MS may remain valid within a RAN, a public land mobile network (PLMN), or a tracking area. An example of this type of model is shown by regional model 410. In another example, for a set of AI or ML features, a model or MS may be generalized across multiple areas and band combinations. An example of this type of model is shown by universal model 415.

In some cases, the network node 110 and/or one or more characteristics associated with the network node 110 may be identified. In one example, a PLMN or a stand-alone non-public network (SNPN) may be identified using a mobile country code (MCC) or a mobile network code (MNC). The MCC or the MNC (or a combination of the MCC and MNC) may be, for example, six digits in length and may include any integer or combinations of integers. In another example, a tracking area may be identified. A tracking area code may be used to identify the tracking area within a scope of the PLMN or SNPN. The tracking area code may include a twenty-four digit bit string. In another example, a RAN area may be identified. A RAN area code may be used to identify the RAN area within a scope of the tracking area. The RAN area code may be any integer between 0-255. In another example, a network node or a cell may be identified. A cell identity may be used to identify the cell within a PLMN or SNPN. The cell identity may be a thirty-six digit bit string. The cell identity may also be used to identify the network node 110 and a cell associated with the network node 110. Any number of bits between the first 22 bits and the first 32 bits of the bit string may be used to identify the network node 110. In another example, an NR carrier frequency may be identified. An absolute radio-frequency channel number (ARFCN) value may be used to indicate an ARFCN that is applicable for a downlink transmission, an uplink transmission, or a bi-directional transmission. The ARFCN value may be any integer between 0 and 3279165.

In some cases, for each AI or ML feature or feature group, there may be a list of local, regional, and/or universal models or model structures that are supported by the UE. Applying a model or MS that is designed for a first function, feature, or feature group to one or more other functions, features, feature groups may result in the model or MS performing with decreased accuracy or efficiency. Although a sufficiently generalized model is desired to reduce requirements of frequent switching of the models, generalizing the model or MS across multiple functions, features, or feature groups may result in the model being too large or reduced performance. Thus, it may be beneficial for the UE and the network node to determine a balance between a model generalization and a model size such that the model is applicable across a number of functions, features, or feature groups but is not too large to be loaded or otherwise used by the UE.

Techniques and apparatuses are described herein for model generalization. In some aspects, a UE may obtain generalization information associated with a model. The UE may initiate a connection to a network node and may filter the model based at least in part on the generalization information. The UE may transmit UE capability information to the network node, based at least in part on filtering the model, that indicates whether the UE is configured to use the model. In some other aspects, the network node may obtain generalization information associated with the model. The network node may receive UE capability information associated with a UE and may filter the model based at least in part on the generalization information and the UE capability information. The network node may transmit an indication, to the UE, that indicates whether the model is configured to be used by the UE.

As described herein, applying a model or MS that is designed for a first function, feature, or feature group to one or more other functions, features, or feature groups may result in the model or MS performing with decreased accuracy or efficiency. Additionally, generalizing the model or MS across each of the functions may result in the model being too large. Using the techniques and apparatuses described herein, the UE may filter the model and may transmit UE capability information to the network node that indicates whether the model is applicable, available at the UE, or supported by the UE. Additionally, or alternatively, the network node may filter the model and may transmit an indication that indicates whether the model is configured to be used by the UE. This may result in the UE being configured with a model that is generalized across one or more functions, features, or feature groups of the UE and that has a size that is capable of being loaded and otherwise used by the UE.

As indicated above, FIG. 4 is provided as an example. Other examples may differ from what is described with regard to FIG. 4.

FIGS. 5A and 5B illustrate examples 500 and 505 of model generalization, in accordance with the present disclosure. The UE 120 may communicate with the network node 110. A server 510 may communicate with the UE 120 and/or the network node 110. In some aspects, the server 510 may be a cloud server that is configured to deploy a model (or multiple models).

In some aspects, as shown by FIG. 5A, generalization information associated with the model may be configured in the network node 110. In this example, the UE 120 may not be configured with the generalization information. Instead, the UE 120 may signal a model identifier, an MS identifier, or a PS identifier in UE capability information. Upon reception of the model identifier, the MS identifier, or the PS identifier, the network node 110 may determine whether the model is applicable for a given set of scenarios or configurations. As shown by reference number 515, the server 510 may transmit, and the network node 110 may receive, generalization information associated with a model, an MS, or a PS associated with the model. In some aspects, the generalization information may be provided to the network node 110 during a deployment of the model. As shown by reference number 520, the UE 120 may transmit, and the network node 110 may receive, UE capability information associated with the UE 120. As shown by reference number 525, the network node 110 may filter the model, the MS, or the PS based at least in part on the generalization information and the UE capability information. As shown by reference number 530, the network node 110 may transmit, and the UE 120 may receive, an indication that indicates whether the model, the MS, or the PS is to be activated, deactivated, or switched by the UE 120. The network node 110 may transmit the indication based at least in part on filtering the model, the MS or the PS.

In some aspects, as shown by FIG. 5B, generalization information associated with the model may be configured in the UE 120. In this example, the UE 120 may signal a model identifier, MS identifier, or PS identifier that is applicable in a current scenario and/or may signal the model identifier, MS identifier, or PS identifier with the generalization information. As shown by reference number 535, the server 510 may transmit, and the UE 120 may receive, generalization information associated with a model, an MS, or a PS associated with the model. In some aspects, the generalization information may be provided to the UE 120 during a deployment of the model. Additionally, or alternatively, the generalization information may be provided during a software update associated with the model. As shown by reference number 540, the UE 120 may initiate a connection with the network node 110. As shown by reference number 545, the UE 120 may filter the model, the MS, or the PS based at least in part on the generalization information or a scope associated with the model, the MS, or the PS. As shown by reference number 550, the UE 120 may transmit, and the network node 110 may receive, UE capability information that indicates whether the UE 120 is configured to use the model, the MS, or the PS. The UE 120 may transmit the UE capability information based at least in part on the UE 120 filtering the model, the MS, or the PS.

In some aspects, the generalization information may include applicability of the model, MS, or PS (e.g., area information). For example, the generalization information may include a cell identifier (ID), a network node ID, or a RAN area code, among other examples. In some aspects, the generalization information may include UE configuration information and/or network node configuration information. For example, the generalization information may include antenna information associated with the UE 120 or the network node 110, such as antenna pattern information, or may include environment information associated with the UE 120 or the network node 110, such as whether the UE 120 or the network node 110 is located indoors or outdoors. In some aspects, the generalization information may include carrier frequency information or may include a list of carrier frequencies. In some aspects, the generalization information may include band information or band combination information. In some aspects, the generalization information may include sub-carrier spacing (SCS) information. In some aspects, the generalization information may include duplexing information, such as time division duplexing (TDD) information or frequency division duplexing (FDD) information. In some aspects, the generalization information may include speed information, such as a speed, a velocity, or orientation information associated with the UE 120. In some aspects, the generalization information may include range information, Doppler information, or delay spread information. In some aspects, the generalization information may include other information not described above.

In some aspects, the model, MS, or PS may be deployed per cell, per network node, per RAN area code, per tracking area, or per PLMN. In some aspects, the model, MS, or PS may be deployed per cell or network node group. For example, the model, MS, or PS may be grouped by an infra-vendor. In some aspects, the model, MS, or PS may be generalized across multiple PLMNs. A signaling overhead during the operation may depend on the deployment scenario.

In some aspects, the UE 120 may signal the supported models, model structures, or parameter sets per cell, per network node, per RAN area code, per tracking area, or per PLMN. In some aspects, to reduce the signaling overhead, the UE 120 may prioritize or filter signaling models or MS identifiers supported in a particular cell, network node, RAN area code, tracking area, or PLMN. In some aspects, for a given AI or ML feature, if the UE 120 has localized models or model structures, then the UE 120 may skip indicating regional and universal models or MS identifiers. If the UE 120 supports localized models when connected to the network node, cell, or network node or cell group, the UE 120 may skip indicating the regional model or model structure identifiers. For example, the UE 120 may skip indicating generalized model or MS identifiers per cell, per network node, per RAN area code, per tracking area, or per PLMN. If the UE 120 does not support localized models for connected network nodes or cells, the UE 120 may indicate regional model or MS identifiers per RAN area or tracking area, among other examples. In some aspects, for a given AI or ML feature, if the UE 120 has universal models or universal model structures, the UE 120 may skip (e.g., refrain from) indicating local and regional models and MS identifiers. If the UE 120 supports a universal model for the feature, the UE 120 may skip indicating regional and local model and MS identifiers. For example, the UE 120 may skip indicating localized model or MS identifiers per cell, per network node, per RAN area, per tracking area, or per PLMN. If the UE 120 does not support universal models but supports regional models, the UE 120 may skip indicating local models or MS identifiers. For example, the UE 120 may skip indicating localized models or MS identifiers per cell or network node.

In some aspects, for efficient signaling of supported localized or regional model or MS identifiers, the UE 120 may be configured with a list of supported model or MS identifiers per cell, per network node, per RAN area, per tracking area, and/or per PLMN. The UE 120 may be configured with supported model/MS/PS IDs per cell, per network node, per RAN area, per tracking area, and/or per PLMN using a model or MS descriptor and/or a model or MS ID assignment. In some aspects, the model or MS descriptor may include the area scope of the model. For example, for each model or MS supported by the UE 120, a model descriptor (including the validity area) may be maintained at the UE 120. In another example, for each feature, the UE 120 may indicate only those models or model structures that are within a validity area (starting from localized, regional, to universal, or in reverse). In some aspects, using the model or MS ID assignment, the UE 120 may infer the area scope of the AI or ML model or MS from the model/MS IDs. The model/MS ID(s) may be assigned such that UE 120 can infer the validity area from the model/MS ID(s). For example, for a cell-specific model/MS ID, the UE 120 may infer PLMN. CellIdentity.Model-ID or PLMN. CellIdentity.MS-ID. In another example, for a RAN specific model/MS ID, the UE 120 may infer PLMN.RAN-AreaCode.Model-ID or PLMN.RAN-AreaCode.MS-ID. In another example, for a tracking area specific model or MS ID, the UE 120 may infer PLMN.TrackingAreaCode.Model-ID or PLMN. TrackingAreaCode.MS-ID.

In some aspects, when a model/MS ID is indicated to the network node 110, the network node 110 may need to obtain UE vendor information and/or area validity information. An indicated model ID may be cell-specific, network node specific, RAN area specific, tracking area specific, or PLMN specific. In some aspects, an international mobile subscriber identity (IMSI), a temporary mobile subscriber identity (TMSI), or UE vendor specific information may not be available to the network node 110. The same model ID may be reused across the cell, network node, RAN area, tracing area, and different vendors. Therefore, when the UE 120 indicates the model/MS ID, the UE 120 should may indicate whether it is cell, network node, RAN area, or tracking area specific. The UE 120 may not need to indicate the actual cell, network node, RAN area, or tracking area.

In some aspects, the UE capability information may include information associated with model/MS IDs that are supported at the UE 120, model/MS IDs that are available to the UE 120 (e.g., need to be downloaded by the UE 120), UE vendor identification information, and/or an indication of whether indicated model/MS IDs are cell, network node, RAN area, tracking area, or PLMN specific. The network node 110 may identify the model/MS IDs based at least in part on this information.

In some aspects, the network node 110 may transmit, and the UE 120 may receive, an indication of a group identifier (group ID). The indication of the group identifier may be transmitted using broadcast or unicast. The group identifier may be associated with a group of cells or network nodes. The UE 120 may use the group ID to identify infra-vendor identity, or a group of cells or network nodes for which the model/model structures have been trained for a given AI or ML feature. In some aspects, the UE 120 may maintain a mapping between group ID and infra-vendor identity. In some aspects, upon reception of the group ID(s), the UE 120 may signal model/MS ID(s) that are supported for the group ID (e.g., the cells or network nodes associated with the group ID). For example, the UE 120 may transmit capability information that indicates the model/MS IDs that are supported for the group ID. In some aspects, similar granularity for UE capability signaling can be maintained.

In some aspects, a generalized model may remain valid for more than one PLMN. In some aspects, the model may be signaled per PLMN identity list. A model that is supported for a PLMN may be assumed to be supported for a list of PLMNs. A list of PLMN identities may be defined per AI or per ML feature. In some aspects, the model may be signaled based at least in part on a hierarchical structure (e.g., only part of model/MS ID is signaled in the UE capability information). For example, a fixed number of maximum bits may be used to represent model/MS IDs. Additionally, or alternatively, the model may be represented using an object identifier. In some aspects, the model may be signaled without any structure. For example, the entire model/MS ID may be signaled using the UE capability information.

Some example model/MS ID registration information and deployment scenarios are shown in Table 1 below.

TABLE 1

| Registration/deployment | Methods for registration | |
|---|---|---|
| scenario | and deployment | UE capability |
| Registered and deployed | Registration and deployment | UE indicates model/MS IDs |
| within mobile network | can be per: | per cell, network node, RAN |
| operator (MNO) network | Cell ID, | area, tracking area, or PLMN |
| Model ID is assigned | Network node ID, | UE filters and |
| by MNO | RAN area code, | prioritizes model/MS |
| | Tracking Area Code, | IDs to be signaled |
| | PLMN. | |
| Registered with infra-vendor | Registration and deployment | UE indicates model/MS IDs |
| Model ID is assigned | can be per: | per cell/network node group |
| by infra-vendors (for | Cell group ID, | ID |
| example, if | Network node group | |
| model/MS are | ID | |
| trained with specific | | |
| infra-vendor) | | |
| Registration using over-the- | Global unique ID is provided | UE signals the model/MS ID |
| top server | Methods are devised | to the network node |
| | to reduce signaling | Methods for |
| | overhead | reducing signaling |
| | | overhead is used |

In some aspects, during the model and PS deployment/registration, the model or PS may be assigned a global unique address (global ID). In some aspects, the global ID may be assigned in accordance with a hierarchical assignment of the global ID. In a first example, the assignment of the global ID may be similar to the assignment of an Internet Protocol (IP) address. The global ID may have a fixed number of maximum bits (for example, X number of bits may be provisioned for ID assignment). The ID may include the MLFN, function, feature, or feature group (X₁ most significant bit)+model ID (X₂ middle significant bit)+parameter set (X₃ least significant bit). In some aspects, the number of bits to reserve for the MLFN, function, feature, or feature group, model ID, and parameter set may depend on the model. In the deployment/registration request for the model, a model designer may indicate for which MLFN, function, feature, or feature group the model is being registered (for example, the model designer indicate X₁). In the deployment/registration for the PS, the model designer may indicate for which MLFN, function, feature, or feature group, and for which model, the PS is being registered (for example, the model designer may indicate X₁ and X₂). In the deployment/registration response, a model repository may assign a unique ID to the model or PS. In a second example, the assignment of the global ID may be similar to the assignment of an object identifier in a tree structure. For example, the MS ID(s) may be deployed or registered as a child of the MLFN, function, feature, or feature group, and the PS ID(s) may be deployed or registered as a child of the MS ID.

In some aspects, a global ID structure may cause signaling overhead. A model designer (e.g., a UE vendor), the UE 120, the network node 110, and a model repository may communicate. The model designer, the UE 120, the network node 110, and the model repository may communicate regarding model deployment and registration, such as for the hierarchical assignment of the global IDs. The UE 120 and the network node 110 may communicate regarding capability signaling, such as to indicate global model and parameter set identifiers. The UE 120 and the network node 110 may communicate model, MS, or PS configuration information, such as using the hierarchical configuration. The UE 120, the network node 110, and/or the model repository may derive the global ID and/or may download the model, MS, or PS using the global ID. The UE 120 and the network node 110 may perform model, MS, or PS activation, deactivation, or switching, such as using the structure of the identifiers and/or other information.

In some aspects, the global ID may be used for mapping to a short ID. The mapping may be permanent, for example, may be assigned during deployment or registration by the model repository. Alternatively, the mapping may be flexible, for example, may be configured by the network node 110. In some aspects, different configurations may have different mappings or different mapping rules. In some aspects, there may be a permanent mapping of global model, MS or PS IDs to short IDs and functions (to derive global ID from short ID). For example, during the model deployment/registration (e.g., in the model deployment/registration response), the server (e.g., model repository) may provide a global unique ID to the model, MS, or parameter set, may provide a short ID from which the global unique ID for the model, MS, or parameter set can be derived, and/or may provide a function to derive the global unique ID from the short ID. The function to derive the global unique ID from the short ID may be assumed to be configured in both the UE 120 and the network node 110. In some aspects, a flexible mapping of the global model, MS or PS ID to the short IDs may be assigned during each AI or ML configuration.

In some aspects, the network node 110 may map a global MS ID to a short (lower bit) MS ID. In some aspects, the network node 110 may map a global PS ID to a short (lower bit) PS ID. In some aspects, the network node 110 may map a short MS ID and PS ID to the UE 120. In some aspects, the short ID may be truncated version of global ID or an index that indicates the global ID or can be used to derive global ID. In some aspects, the short ID may be indicated in Layer 2 or Layer 3 signaling during configuration, activation, and/or deactivation to reduce signaling overhead. In some aspects, the short (lower bit) MS IDs and PS IDs can be used to indicate model IDs and PS IDs during AI configuration, indicate model or PS switching, or facilitate activation, deactivation, fallback (for a given MS ID and PS ID), and/or switching (from a given MS ID and PS ID to another MS ID or PS ID), among other examples.

In some aspects, the permanent mapping of the global ID to the short ID may be used to reduce the signaling overhead. In some aspects, the model designer, UE 120, network node 110, and the model repository may exchange the global model, MS, or PS IDs, short IDs (X), and/or a function to derive global ID from short ID. The UE 120 and the network node 110 may communicate capability signaling, such as the short ID (X) (for example, the network node 110 may derive global ID from short ID). The UE 120 and the network node 110 may communicate regarding the model, MS, or PS configuration, such as the short ID (X) (for example, the UE 120 may derive global ID from short ID). The UE 120, the network node 110, and/or the model repository may derive a global cell ID from the short ID, and/or may download the model or PS using the global ID. The UE 120 and the network node 110 may communicate regarding the model, MS, or PS activation, deactivation, or switching, such as using the short ID.

In some aspects, the network node 110 may assign the mapping of the global ID and/or the short ID (per configuration) using a flexible mapping. In some aspects, the model designer, UE 120, network node 110, and the model repository may exchange model registration information. The model registration information may include, for example, a global ID assignment for the model, MS, or PS (which may or may not be a hierarchical assignment). The UE 120 and the network node 110 may communicate capability signaling associated with the global model, the MS, or the PS IDs. The UE 120 and the network node 110 may communicate regarding the model, MS, or PS configuration. For example, the network node 110 may provide a mapping between the global IDs and a temporary provision of short IDs within a configuration. The UE 120, the network node 110, and/or the model repository may derive a global cell ID from the short ID, and/or may download the model, MS, or PS. For example, the UE 120 may map the global cell ID from the short ID and the UE 120, network node 110, or model repository may download the model, MS, or PS using the global ID. The UE 120 and the network node 110 may communicate regarding the model, MS, or PS activation, deactivation, or switching, such as using the short ID and/or other information.

In some aspects, the UE 120 and the network node 110 may communicate capability signaling. The UE capability signaling may indicate the global ID(s), the short ID(s), and/or the truncated ID(s). The network node 110 may derive the global ID from the short ID or the truncated ID. In some aspects, the network node 110 may transmit a request for the UE capability information to the UE 120, and the UE 120 may transmit a response to the network node 110 that includes the UE capability information.

In some aspects, there may be different methods for configuring the model, MS, or PS to the UE 120. In some aspects, a single MLFN and MS/model is configured per configuration, and the PS may be changed for the MLFN and MS ID. The configuration ID may be used to map the MLFN and the model ID. The global ID may be used to derive the global ID (PS) from the short/truncated ID (PS). The global ID may be derived from the short/truncated ID using the hierarchical structure of the PS IDs. A permanent mapping or a flexible mapping may be indicated in the configuration. In some aspects, a single MLFN may be configured per configuration, and the model or the PS can be changed for the MLFN. The configuration ID may be used to map the MLFN. The global ID (MS and PS) may be derived from the short ID (MS and PS). The global ID may be derived from the short/truncated IDs using the hierarchical structure of the MS or PS IDs. A permanent mapping or a flexible mapping may be indicated in the configuration. In some aspects, multiple MLFNs may be configured per configuration, and the model or PS can be changed per MLFN. In some aspects, the global ID (MLFN, MS, or PS) can be derived from the short ID (MLFN, MS, or PS). An index in the configuration may be indicated to derive the MLFN. The global ID(s) may be derived from the short/truncated ID(s) using a hierarchical structure of the MS and the PS IDs. A permanent or flexible mapping may be used based at least in part on the configuration.

In some aspects, an AI/ML configuration may be retained, modified, or released during a handover. A network (such as a serving network node 110 or a target network node 110) may explicitly indicate which AI/ML configuration IDs are retained, modified, and/or released. During the modification of the model, the MS or PS IDs may be retained, reassigned, or released.

In some aspects, the UE 120 may download the model, MS, or PS. In some aspects, the UE 120 may derive/map the global ID(s) from the short ID(s). Additionally, or alternatively, the UE 120 may construct a URL using the global ID. For example, the UE 120 may construct a domain name of a model for querying and upload/download, and a global model ID may be constructed or mapped from short/truncated ID. The UE 120 may transmit, to the model repository, a model, MS, or PS download request. The model repository may transmit, to the UE 120, the model, MS, or PS. In some aspects, the model may transmit, to a domain name system (DNS) or a model coordinator (e.g., a model and data access coordinator (MDAC)), a model or parameter set download request. The DNS/MDAC may determine a URL for the model, MS, or PS set downloading. The DNS/MDAC may transmit, to the model repository, a model, MS, or PS download request. The model repository may transmit, to the UE 120, the model or PS. In some aspects, the UE 120 may construct a fully qualified domain name (FQDN) model ID or PS ID and may query the DNS/MDAC for the URL of the model repository. Additionally, or alternatively, the UE 120 may directly construct the URL (including the FQDN) for requesting the model ID or the PS ID from the model repository. An example of FQDN construction using the MLFN, MS ID, and PS ID is shown below:

```
GlobalID-MLFN<highest-byte>.GlbalID-MSID<second-highest-byte>.GlobalID-
PSID<lowest-byte>.GlbalID.NRC.MNC<MNC>.MCC<MCC.3gppnetwork.org, e.g.,
  [MLFN].[Model_ID].[PS_ID].3gppnetwork.org
  [MLFN].[Model_ID].[PS_ID].MCCabc.MNCxyz.3gppnetwork.org
GlobalID-PSID<lowest-byte>.GlbalID-MSID<second-highest-byte>.GlobalID-
MLFN<lowest-byte>.GlbalID.NRC.MNC<MNC>.MCC<MCC.3gppnetwork.org, e.g.,
  [PS_ID].[Model_ID].[MLFN].3gppnetwork.org
  [PS_ID].[Model_ID].[MLFN].MCCabc.MNCxyz.3gppnetwork.org
```

In some aspects, the configuration may define how the network (e.g., the network node 110) can activate, deactivate, or perform switching. In one example, if a single MLFN and model/MS is configured per configuration, the network node 110 may indicate a configuration ID and a PS index/short/truncated ID to activate, deactivate, and/or perform switching (to another PS). In another example, a single MLFN may be configured per configuration. For model/MS activation, deactivation, or switching, the network node 110 may indicate a configuration ID, a model/MS index within the configuration, or a short ID for the MS/model. In another example, the NG-RAN use short ID/index (based on provided mapping of global ID and short ID/index in the configuration message) to perform/indicate model/MS activation, deactivation, or switching. A default PS may be used for model switching and/or the network node 110 can indicate the PS ID. For parameter set activation, deactivation, or switching, the network node 110 may indicate a configuration ID, a model/MS index within the configuration, a short/truncated ID for MS, and PS index, or a short/truncated ID within indexed MS ID. In another example, multiple MLFNs may be indicated per configuration. The network node 110 may need to provide the index or short ID for the MLFN and for the model, MS, or PS activation, deactivation, or switching.

As described herein, applying a model or MS that is designed for a first function to one or more other functions may result in the model or MS performing with decreased accuracy or efficiency. However, generalizing the model or MS across each of the functions may result in the model being too large. Using the techniques and apparatuses described herein, the UE may filter the model and may transmit UE capability information to the network node that indicates whether the UE is configured to use the model. Additionally, or alternatively, the network node may filter the model and may transmit an indication that indicates whether the model is configured to be used by the UE. This may result in the UE being configured with a model that is generalized across one or more functions of the UE and that has a size that is capable of being loaded and otherwise used by the UE.

As indicated above, FIGS. 5A-5B are provided as examples. Other examples may differ from what is described with regard to FIGS. 5A-5B.

FIG. 6 is a diagram illustrating an example process 600 performed, for example, by a UE, in accordance with the present disclosure. Example process 600 is an example where the UE (e.g., UE 120) performs operations associated with model generalization.

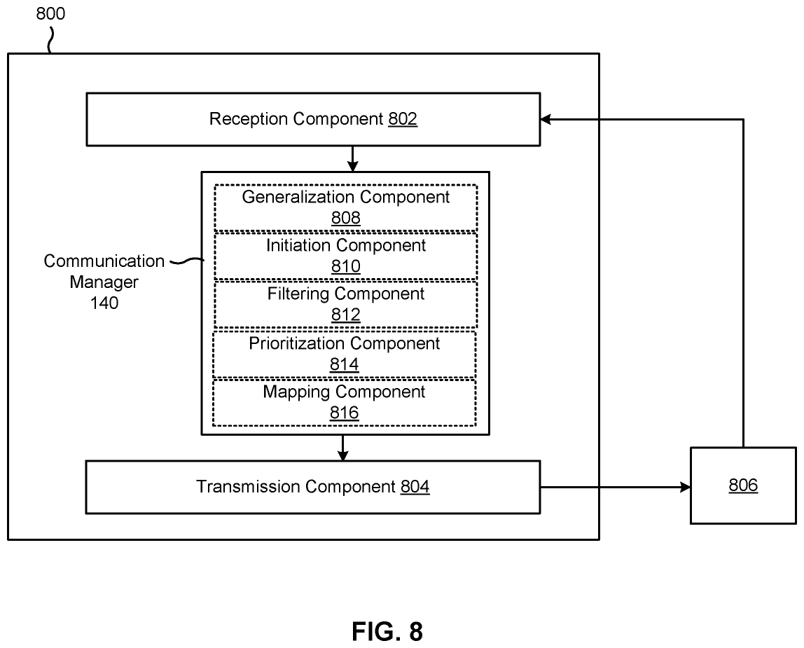

As shown in FIG. 6, in some aspects, process 600 may include obtaining generalization information associated with a model, an MS, or a PS associated with the model (block 610). For example, the UE (e.g., using communication manager 140 and/or generalization component 808, depicted in FIG. 8) may obtain generalization information associated with a model, an MS, or a PS associated with the model, as described above.

As further shown in FIG. 6, in some aspects, process 600 may include initiating a connection to a network node (block 620). For example, the UE (e.g., using communication manager 140 and/or initiation component 810, depicted in FIG. 8) may initiate a connection to a network node, as described above.

As further shown in FIG. 6, in some aspects, process 600 may include filtering the model, the MS, or the PS based at least in part on the generalization information (block 630). For example, the UE (e.g., using communication manager 140 and/or filtering component 812, depicted in FIG. 8) may filter the model, the MS, or the PS based at least in part on the generalization information, as described above.

As further shown in FIG. 6, in some aspects, process 600 may include transmitting UE capability information to the network node, based at least in part on filtering the model, the MS or the PS, that indicates whether the model, the MS, or the PS is applicable, available, or supported by the UE (block 640). For example, the UE (e.g., using communication manager 140 and/or transmission component 804, depicted in FIG. 8) may transmit UE capability information to the network node, based at least in part on filtering the model, the MS or the PS, that indicates whether the model, the MS, or the PS is applicable, available, or supported by the UE, as described above.

Process 600 may include additional aspects, such as any single aspect or any combination of aspects described below and/or in connection with one or more other processes described elsewhere herein.

In a first aspect, filtering the model, the MS, or the PS based at least in part on the generalization information comprises filtering the model, the MS, or the PS based at least in part on a scope associated with the model, the MS, or the PS, wherein the scope is indicated in a model structure identifier or a model descriptor associated with the model, the MS, or the PS.

In a second aspect, alone or in combination with the first aspect, obtaining the generalization information comprises receiving the generalization information from a server.

In a third aspect, alone or in combination with one or more of the first and second aspects, receiving the generalization information from the server comprises receiving a software update from the server that includes the generalization information.

In a fourth aspect, alone or in combination with one or more of the first through third aspects, receiving the generalization information from the server comprises receiving the generalization information from the server during a deployment of the model, the MS, or the PS.

In a fifth aspect, alone or in combination with one or more of the first through fourth aspects, the generalization information includes at least one of area information, location information, network node configuration information, UE configuration information, antenna information, carrier frequency information, band information, sub-carrier spacing information, time division duplexing information, frequency division duplexing information, speed information, range information, Doppler information, or delay spread information.

In a sixth aspect, alone or in combination with one or more of the first through fifth aspects, the model, the MS, or the PS is deployed per cell, per network node, per radio access network area code, per tracking area, or per public land mobile network.

In a seventh aspect, alone or in combination with one or more of the first through sixth aspects, the model, the MS, or the PS is deployed for a group of cells or a group of network nodes.

In an eighth aspect, alone or in combination with one or more of the first through seventh aspects, the model, the MS or the PS is generalized across multiple public land mobile networks.

In a ninth aspect, alone or in combination with one or more of the first through eighth aspects, process 600 includes transmitting an indication of model, MS, or PS identifiers that are supported by the UE, wherein the indication is transmitted per cell, per network node, per radio access network area code, per tracking area, or per public land mobile network.

In a tenth aspect, alone or in combination with one or more of the first through ninth aspects, process 600 includes prioritizing a filtering of model, MS, or PS identifiers that are supported in a particular cell, network node, radio access network area code, tracking area, or public land mobile network.

In an eleventh aspect, alone or in combination with one or more of the first through tenth aspects, process 600 includes refraining from transmitting an indication of a local model, a local MS, or a local PS identifier based at least in part on the UE being configured with a global model, the MS, or the PS.

In a twelfth aspect, alone or in combination with one or more of the first through eleventh aspects, process 600 includes receiving an indication of model, MS, or PS identifiers that are supported by the UE per cell, per network node, per radio access network area code, per tracking area, or per public land mobile network.

In a thirteenth aspect, alone or in combination with one or more of the first through twelfth aspects, the indication includes model descriptor information or model assignment information.

In a fourteenth aspect, alone or in combination with one or more of the first through thirteenth aspects, the UE capability information comprises model, MS, or PS identifiers that are supported by the UE, model, MS, or PS identifiers that are available to the UE, UE vendor information, or information that indicates whether a model, MS, or PS identifier is cell specific, network node specific, radio access network area code specific, tracking area specific, or public land mobile network specific.

In a fifteenth aspect, alone or in combination with one or more of the first through fourteenth aspects, process 600 includes receiving, from the network node, a group identifier associated with a plurality of network nodes.

In a sixteenth aspect, alone or in combination with one or more of the first through fifteenth aspects, the group identifier is used by the UE to identify infra-vendor information or network node grouping information associated with a training of the model, the MS, or the PS.

In a seventeenth aspect, alone or in combination with one or more of the first through sixteenth aspects, process 600 includes storing a mapping between the group identifier and an infra-vendor identifier.

In an eighteenth aspect, alone or in combination with one or more of the first through seventeenth aspects, process 600 includes transmitting an indication of a model, MS, or PS identifier that is supported for the network nodes associated with the group identifier.

In a nineteenth aspect, alone or in combination with one or more of the first through eighteenth aspects, the indication of the model, MS, or PS identifier is transmitted per public land mobile network identity list.

In a twentieth aspect, alone or in combination with one or more of the first through nineteenth aspects, the indication of the model, MS, or PS identifier is transmitted in accordance with a hierarchical structure.

In a twenty-first aspect, alone or in combination with one or more of the first through twentieth aspects, the indication of the model, MS, or PS identifier is transmitted with the UE capability information.

In a twenty-second aspect, alone or in combination with one or more of the first through twenty-first aspects, process 600 includes receiving an indication of a global identifier associated with the model, the MS, or the PS.

In a twenty-third aspect, alone or in combination with one or more of the first through twenty-second aspects, the global identifier is received in accordance with a hierarchical assignment of the global identifier.

In a twenty-fourth aspect, alone or in combination with one or more of the first through twenty-third aspects, process 600 includes mapping the global identifier associated with the model, the MS, or the PS to a short identifier associated with the model, the MS or the PS.

In a twenty-fifth aspect, alone or in combination with one or more of the first through twenty-fourth aspects, the mapping of the global identifier to the short identifier is a permanent mapping or is a flexible mapping.

In a twenty-sixth aspect, alone or in combination with one or more of the first through twenty-fifth aspects, the UE capability information includes an indication of the global identifier or the short identifier.

In a twenty-seventh aspect, alone or in combination with one or more of the first through twenty-sixth aspects, a single machine learning function or feature name and a single model or MS identifier is indicated per configuration.

In a twenty-eighth aspect, alone or in combination with one or more of the first through twenty-seventh aspects, a single machine learning function or feature name is indicated per configuration.

In a twenty-ninth aspect, alone or in combination with one or more of the first through twenty-eighth aspects, multiple machine learning function or feature names are indicated per configuration.

In a thirtieth aspect, alone or in combination with one or more of the first through twenty-ninth aspects, one or more configurations of the model are retained during a handover operation.

In a thirty-first aspect, alone or in combination with one or more of the first through thirtieth aspects, process 600 includes receiving, from the network node, an indication of one or more configuration identifiers associated with one or more configurations of the model that are retained, modified, or released.

In a thirty-second aspect, alone or in combination with one or more of the first through thirty-first aspects, process 600 includes downloading the model, the MS, or the PS associated with the model or the MS.

In a thirty-third aspect, alone or in combination with one or more of the first through thirty-second aspects, a configuration of the model indicates how the network node can activate, deactivate, or switch between models, model structures, or parameter sets.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with model generalization.

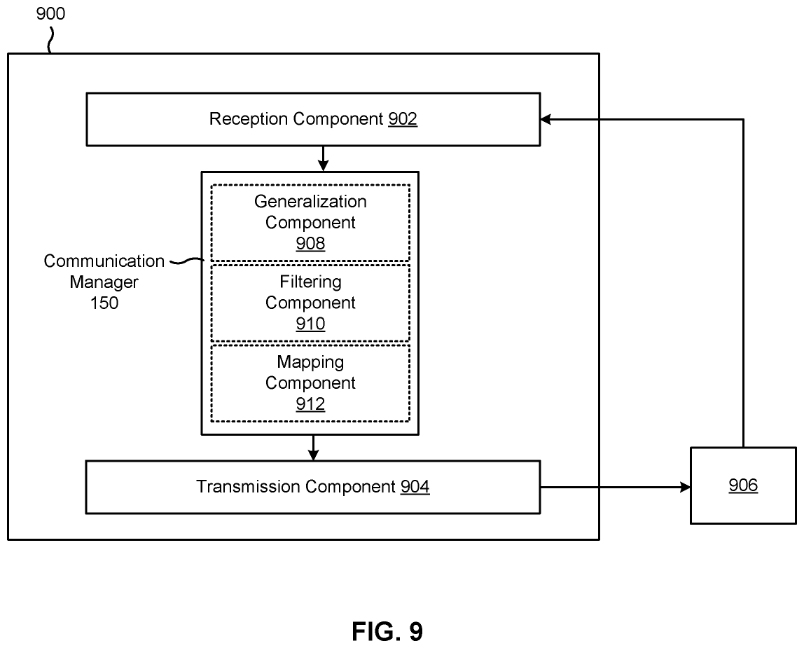

As shown in FIG. 7, in some aspects, process 700 may include obtaining generalization information associated with a model, an MS, or a PS associated with the model (block 710). For example, the network node (e.g., using communication manager 150 and/or generalization component 908, depicted in FIG. 9) may obtain generalization information associated with a model, an MS, or a PS associated with the model, as described above.

As further shown in FIG. 7, in some aspects, process 700 may include receiving UE capability information associated with a UE (block 720). For example, the network node (e.g., using communication manager 150 and/or reception component 902, depicted in FIG. 9) may receive UE capability information associated with a UE, as described above.

As further shown in FIG. 7, in some aspects, process 700 may include filtering the model, the MS, or the PS based at least in part on the generalization information and the UE capability information (block 730). For example, the network node (e.g., using communication manager 150 and/or filtering component 910, depicted in FIG. 0) may filter the model, the MS, or the PS based at least in part on the generalization information and the UE capability information, as described above.

As further shown in FIG. 7, in some aspects, process 700 may include transmitting an indication, to the UE, that indicates whether the model, the MS, or the PS is to be activated, deactivated, or switched by the UE (block 740). For example, the network node (e.g., using communication manager 150 and/or transmission component 904, depicted in FIG. 9) may transmit an indication, to the UE, that indicates whether the model, the MS, or the PS is to be activated, deactivated, or switched by the UE, as described above.

Process 700 may include additional aspects, such as any single aspect or any combination of aspects described below and/or in connection with one or more other processes described elsewhere herein.

In a first aspect, filtering the model, the MS, or the PS comprises filtering model, MS, or PS identifiers associated with the model, the MS, or the PS.

In a second aspect, alone or in combination with the first aspect, obtaining the generalization information comprises receiving the generalization information from a server.

In a third aspect, alone or in combination with one or more of the first and second aspects, receiving the generalization information from the server comprises receiving the generalization information from the server during a deployment of the model, the MS, or the PS.

In a fourth aspect, alone or in combination with one or more of the first through third aspects, the generalization information includes at least one of area information, location information, network node configuration information, UE configuration information, antenna information, carrier frequency information, band information, sub-carrier spacing information, time division duplexing information, frequency division duplexing information, speed information, range information, doppler information, or delay spread information.

In a fifth aspect, alone or in combination with one or more of the first through fourth aspects, the model, the MS, or the PS is deployed per cell, per network node, per radio access network area code, per tracking area, or per public land mobile network.

In a sixth aspect, alone or in combination with one or more of the first through fifth aspects, the model, the MS, or the PS is deployed for a group of cells or a group of network nodes.

In a seventh aspect, alone or in combination with one or more of the first through sixth aspects, the model, the MS, or the PS is generalized across multiple public land mobile networks.

In an eighth aspect, alone or in combination with one or more of the first through seventh aspects, process 700 includes receiving an indication of model, MS, or PS identifiers that are supported by the UE, wherein the indication is received per cell, per network node, per radio access network area code, per tracking area, or per public land mobile network.

In a ninth aspect, alone or in combination with one or more of the first through eighth aspects, process 700 includes transmitting an indication of model, MS, or PS identifiers that are supported by the UE per cell, per network node, per radio access network area code, per tracking area, or per public land mobile network.

In a tenth aspect, alone or in combination with one or more of the first through ninth aspects, the indication includes model, MS, or PS descriptor information or model, MS, or PS assignment information.

In an eleventh aspect, alone or in combination with one or more of the first through tenth aspects, the UE capability information comprises model, MS, or PS identifiers that are supported by the UE, model, MS, or PS identifiers that are available to the UE, UE vendor information, or information that indicates whether a model, MS, or PS identifier is cell specific, network node specific, radio access network area code specific, tracking area specific, or public land mobile network specific.

In a twelfth aspect, alone or in combination with one or more of the first through eleventh aspects, process 700 includes transmitting, to the UE, a group identifier associated with a plurality of network nodes.

In a thirteenth aspect, alone or in combination with one or more of the first through twelfth aspects, process 700 includes receiving an indication of a model, MS, or PS identifier that is supported for the network nodes associated with the group identifier.

In a fourteenth aspect, alone or in combination with one or more of the first through thirteenth aspects, the indication of the model, MS, or PS identifier is received per public land mobile network identity list.

In a fifteenth aspect, alone or in combination with one or more of the first through fourteenth aspects, the indication of the model, MS, or PS identifier is received in accordance with a hierarchical structure.

In a sixteenth aspect, alone or in combination with one or more of the first through fifteenth aspects, the indication of the model, MS, or PS identifier is received with the UE capability information.

In a seventeenth aspect, alone or in combination with one or more of the first through sixteenth aspects, process 700 includes transmitting an indication of a global identifier associated with the model, the MS, or the PS.

In an eighteenth aspect, alone or in combination with one or more of the first through seventeenth aspects, the global identifier is transmitted in accordance with a hierarchical assignment of the global identifier.

In a nineteenth aspect, alone or in combination with one or more of the first through eighteenth aspects, process 700 includes obtaining a short identifier associated with the model, the MS, or the PS that is based at least in part on a mapping of the global identifier to the short identifier.

In a twentieth aspect, alone or in combination with one or more of the first through nineteenth aspects, the mapping of the global identifier to the short identifier is a permanent mapping or is a flexible mapping.

In a twenty-first aspect, alone or in combination with one or more of the first through twentieth aspects, the UE capability information includes an indication of the global identifier or the short identifier.

In a twenty-second aspect, alone or in combination with one or more of the first through twenty-first aspects, a single machine learning function or feature name and a single model or MS identifier is indicated per configuration.

In a twenty-third aspect, alone or in combination with one or more of the first through twenty-second aspects, a single machine learning or feature function name is indicated per configuration.

In a twenty-fourth aspect, alone or in combination with one or more of the first through twenty-third aspects, multiple machine learning function or feature names are indicated per configuration.

In a twenty-fifth aspect, alone or in combination with one or more of the first through twenty-fourth aspects, one or more configurations of the model are retained during a handover operation.

In a twenty-sixth aspect, alone or in combination with one or more of the first through twenty-fifth aspects, process 700 includes transmitting, to the UE, an indication of one or more configuration identifiers associated with one or more configurations of the model or the MS that are retained, modified, or released.

In a twenty-seventh aspect, alone or in combination with one or more of the first through twenty-sixth aspects, a configuration of the model, the MS, or the PS indicates how the network node can activate, deactivate, or switch between models, model structures, or parameter sets.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a generalization component 808, an initiation component 810, a filtering component 812, a prioritization component 814, or a mapping component 816, among other examples.

In some aspects, the apparatus 800 may be configured to perform one or more operations described herein in connection with FIGS. 5A-5B. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The generalization component 808 may obtain generalization information associated with a model, an MS, or a PS associated with the model. The initiation component 810 may initiate a connection to a network node. The filtering component 812 may filter the model, the MS, or the PS based at least in part on the generalization information. The transmission component 804 may transmit UE capability information to the network node, based at least in part on filtering the model, the MS or the PS, that indicates whether the model, the MS, or the PS is applicable, available, or supported by the UE.

The transmission component 804 may transmit an indication of model, MS, or PS identifiers that are supported by the UE, wherein the indication is transmitted per cell, per network node, per radio access network area code, per tracking area, or per public land mobile network. The prioritization component 814 may prioritize a filtering of model, MS, or PS identifiers that are supported in a particular cell, network node, radio access network area code, tracking area, or public land mobile network. The transmission component 804 may refrain from transmitting an indication of a local model, a local MS, or a local PS identifier based at least in part on the UE being configured with a global model, the MS, or the PS. The reception component 802 may receive an indication of model, MS, or PS identifiers that are supported by the UE per cell, per network node, per radio access network area code, per tracking area, or per public land mobile network. The reception component 802 may receive, from the network node, a group identifier associated with a plurality of network nodes. The mapping component 816 may store a mapping between the group identifier and an infra-vendor identifier. The transmission component 804 may transmit an indication of a model, MS, or PS identifier that is supported for the network nodes associated with the group identifier. The reception component 802 may receive an indication of a global identifier associated with the model, the MS, or the PS. The mapping component 816 may map the global identifier associated with the model, the MS, or the PS to a short identifier associated with the model, the MS or the PS. The reception component 802 may receive, from the network node, an indication of one or more configuration identifiers associated with one or more configurations of the model that are retained, modified, or released.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include one or more of a generalization component 908, a filtering component 910, or a mapping component 912, among other examples.

In some aspects, the apparatus 900 may be configured to perform one or more operations described herein in connection with FIGS. 5A-5B. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The generalization component 908 may obtain generalization information associated with a model, an MS, or a PS associated with the model. The reception component 902 may receive UE capability information associated with a UE. The filtering component 910 may filter the model, the MS, or the PS based at least in part on the generalization information and the UE capability information. The transmission component 904 may transmit an indication, to the UE, that indicates whether the model, the MS, or the PS is to be activated, deactivated, or switched by the UE.

The reception component 902 may receive an indication of model, MS, or PS identifiers that are supported by the UE, wherein the indication is received per cell, per network node, per radio access network area code, per tracking area, or per public land mobile network. The transmission component 904 may transmit an indication of model, MS, or PS identifiers that are supported by the UE per cell, per network node, per radio access network area code, per tracking area, or per public land mobile network. The transmission component 904 may transmit, to the UE, a group identifier associated with a plurality of network nodes. The reception component 902 may receive an indication of a model, MS, or PS identifier that is supported for the network nodes associated with the group identifier. The transmission component 904 may transmit an indication of a global identifier associated with the model, the MS, or the PS. The mapping component 912 may obtain a short identifier associated with the model, the MS, or the PS that is based at least in part on a mapping of the global identifier to the short identifier. The transmission component 904 may transmit, to the UE, an indication of one or more configuration identifiers associated with one or more configurations of the model or the MS that are retained, modified, or released.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: obtaining generalization information associated with a model, a model structure (MS), or a parameter set (PS) associated with the model; initiating a connection to a network node; filtering the model, the MS, or the PS based at least in part on the generalization information; and transmitting UE capability information to the network node, based at least in part on filtering the model, the MS or the PS, that indicates whether the model, the MS, or the PS is applicable, available, or supported by the UE.

Aspect 2: The method of Aspect 1, wherein filtering the model, the MS, or the PS based at least in part on the generalization information comprises filtering the model, the MS, or the PS based at least in part on a scope associated with the model, the MS, or the PS, wherein the scope is indicated in a model structure identifier or a model descriptor associated with the model, the MS, or the PS.

Aspect 3: The method of any of Aspects 1-2, wherein obtaining the generalization information comprises receiving the generalization information from a server.

Aspect 4: The method of Aspect 3, wherein receiving the generalization information from the server comprises receiving a software update from the server that includes the generalization information.

Aspect 5: The method of Aspect 3, wherein receiving the generalization information from the server comprises receiving the generalization information from the server during a deployment of the model, the MS, or the PS.

Aspect 6: The method of any of Aspects 1-5, wherein the generalization information includes at least one of area information, location information, network node configuration information, UE configuration information, antenna information, carrier frequency information, band information, sub-carrier spacing information, time division duplexing information, frequency division duplexing information, speed information, range information, Doppler information, or delay spread information.

Aspect 7: The method of any of Aspects 1-6, wherein the model, the MS, or the PS is deployed per cell, per network node, per radio access network area code, per tracking area, or per public land mobile network.

Aspect 8: The method of any of Aspects 1-7, wherein the model, the MS, or the PS is deployed for a group of cells or a group of network nodes.

Aspect 9: The method of any of Aspects 1-8, wherein the model, the MS or the PS is generalized across multiple public land mobile networks.

Aspect 10: The method of any of Aspects 1-9, further comprising transmitting an indication of model, MS, or PS identifiers that are supported by the UE, wherein the indication is transmitted per cell, per network node, per radio access network area code, per tracking area, or per public land mobile network.

Aspect 11: The method of any of Aspects 1-10, further comprising prioritizing a filtering of model, MS, or PS identifiers that are supported in a particular cell, network node, radio access network area code, tracking area, or public land mobile network.

Aspect 12: The method of any of Aspects 1-11, further comprising refraining from transmitting an indication of a local model, a local MS, or a local PS identifier based at least in part on the UE being configured with a global model, the MS, or the PS.

Aspect 13: The method of any of Aspects 1-12, further comprising receiving an indication of model, MS, or PS identifiers that are supported by the UE per cell, per network node, per radio access network area code, per tracking area, or per public land mobile network.

Aspect 14: The method of Aspect 13, wherein the indication includes model descriptor information or model assignment information.

Aspect 15: The method of any of Aspects 1-14, wherein the UE capability information comprises model, MS, or PS identifiers that are supported by the UE, model, MS, or PS identifiers that are available to the UE, UE vendor information, or information that indicates whether a model, MS, or PS identifier is cell specific, network node specific, radio access network area code specific, tracking area specific, or public land mobile network specific.

Aspect 16: The method of any of Aspects 1-15, further comprising receiving, from the network node, a group identifier associated with a plurality of network nodes.

Aspect 17: The method of Aspect 16, wherein the group identifier is used by the UE to identify infra-vendor information or network node grouping information associated with a training of the model, the MS, or the PS.

Aspect 18: The method of Aspect 16, further comprising storing a mapping between the group identifier and an infra-vendor identifier.

Aspect 19: The method of Aspect 16, further comprising transmitting an indication of a model, MS, or PS identifier that is supported for the network nodes associated with the group identifier.

Aspect 20: The method of Aspect 19, wherein the indication of the model, MS, or PS identifier is transmitted per public land mobile network identity list.

Aspect 21: The method of Aspect 19, wherein the indication of the model, MS, or PS identifier is transmitted in accordance with a hierarchical structure.

Aspect 22: The method of Aspect 19, wherein the indication of the model, MS, or PS identifier is transmitted with the UE capability information.

Aspect 23: The method of any of Aspects 1-22, further comprising receiving an indication of a global identifier associated with the model, the MS, or the PS.

Aspect 24: The method of Aspect 23, wherein the global identifier is received in accordance with a hierarchical assignment of the global identifier.

Aspect 25: The method of Aspect 23, further comprising mapping the global identifier associated with the model, the MS, or the PS to a short identifier associated with the model, the MS or the PS.

Aspect 26: The method of Aspect 25, wherein the mapping of the global identifier to the short identifier is a permanent mapping or is a flexible mapping.

Aspect 27: The method of Aspect 25, wherein the UE capability information includes an indication of the global identifier or the short identifier.

Aspect 28: The method of any of Aspects 1-27, wherein a machine learning function, feature, or feature group name, and a model or MS identifier, is indicated per configuration.

Aspect 29: The method of any of Aspects 1-28, wherein a machine learning function, feature, or feature group name is indicated per configuration.

Aspect 30: The method of any of Aspects 1-29, wherein multiple machine learning functions, features or feature group names are indicated per configuration.

Aspect 31: The method of any of Aspects 1-30, wherein one or more configurations of the model are retained during a handover operation.

Aspect 32: The method of any of Aspects 1-31, further comprising receiving, from the network node, an indication of one or more configuration identifiers associated with one or more configurations of the model that are retained, modified, or released.

Aspect 33: The method of any of Aspects 1-32, further comprising downloading the model, the MS, or the PS associated with the model or the MS.

Aspect 34: The method of any of Aspects 1-33, wherein a configuration of the model indicates how the network node can activate, deactivate, or switch between models, model structures, or parameter sets.

Aspect 35: A method of wireless communication performed by a network node, comprising: obtaining generalization information associated with a model, a model structure (MS), or a parameter set (PS) associated with the model; receiving user equipment (UE) capability information associated with a UE; filtering the model, the MS, or the PS based at least in part on the generalization information and the UE capability information; and transmitting an indication, to the UE, that indicates whether the model, the MS, or the PS is to be activated, deactivated, or switched by the UE.

Aspect 36: The method of Aspect 35, wherein filtering the model, the MS, or the PS comprises filtering model, MS, or PS identifiers associated with the model, the MS, or the PS.

Aspect 37: The method of any of Aspects 35-36, wherein obtaining the generalization information comprises receiving the generalization information from a server.

Aspect 38: The method of Aspect 37, wherein receiving the generalization information from the server comprises receiving the generalization information from the server during a deployment of the model, the MS, or the PS.

Aspect 39: The method of any of Aspects 35-38, wherein the generalization information includes at least one of area information, location information, network node configuration information, UE configuration information, antenna information, carrier frequency information, band information, sub-carrier spacing information, time division duplexing information, frequency division duplexing information, speed information, range information, doppler information, or delay spread information.

Aspect 40: The method of any of Aspects 35-39, wherein the model, the MS, or the PS is deployed per cell, per network node, per radio access network area code, per tracking area, or per public land mobile network.

Aspect 41: The method of any of Aspects 35-40, wherein the model, the MS, or the PS is deployed for a group of cells or a group of network nodes.

Aspect 42: The method of any of Aspects 35-41, wherein the model, the MS, or the PS is generalized across multiple public land mobile networks.

Aspect 43: The method of any of Aspects 35-42, further comprising receiving an indication of model, MS, or PS identifiers that are supported by the UE, wherein the indication is received per cell, per network node, per radio access network area code, per tracking area, or per public land mobile network.

Aspect 44: The method of any of Aspects 35-43, further comprising transmitting an indication of model, MS, or PS identifiers that are supported by the UE per cell, per network node, per radio access network area code, per tracking area, or per public land mobile network.

Aspect 45: The method of Aspect 44, wherein the indication includes model, MS, or PS descriptor information or model, MS, or PS assignment information.

Aspect 46: The method of any of Aspects 35-45, wherein the UE capability information comprises model, MS, or PS identifiers that are supported by the UE, model, MS, or PS identifiers that are available to the UE, UE vendor information, or information that indicates whether a model, MS, or PS identifier is cell specific, network node specific, radio access network area code specific, tracking area specific, or public land mobile network specific.

Aspect 47: The method of any of Aspects 35-46, further comprising transmitting, to the UE, a group identifier associated with a plurality of network nodes.

Aspect 48: The method of Aspect 47, further comprising receiving an indication of a model, MS, or PS identifier that is supported for the network nodes associated with the group identifier.

Aspect 49: The method of Aspect 48, wherein the indication of the model, MS, or PS identifier is received per public land mobile network identity list.

Aspect 50: The method of Aspect 48, wherein the indication of the model, MS, or PS identifier is received in accordance with a hierarchical structure.

Aspect 51: The method of Aspect 48, wherein the indication of the model, MS, or PS identifier is received with the UE capability information.

Aspect 52: The method of any of Aspects 35-51, further comprising transmitting an indication of a global identifier associated with the model, the MS, or the PS.

Aspect 53: The method of Aspect 52, wherein the global identifier is transmitted in accordance with a hierarchical assignment of the global identifier.

Aspect 54: The method of Aspect 52, further comprising obtaining a short identifier associated with the model, the MS, or the PS that is based at least in part on a mapping of the global identifier to the short identifier.

Aspect 55: The method of Aspect 54, wherein the mapping of the global identifier to the short identifier is a permanent mapping or is a flexible mapping.

Aspect 56: The method of Aspect 54, wherein the UE capability information includes an indication of the global identifier or the short identifier.

Aspect 57: The method of any of Aspects 35-56, wherein a single machine learning function or feature name and a single model or MS identifier is indicated per configuration.

Aspect 58: The method of any of Aspects 35-57, wherein a single machine learning or feature function name is indicated per configuration.

Aspect 59: The method of any of Aspects 35-58, wherein multiple machine learning function or feature names are indicated per configuration.

Aspect 60: The method of any of Aspects 35-59, wherein one or more configurations of the model are retained during a handover operation.

Aspect 61: The method of any of Aspects 35-60, further comprising transmitting, to the UE, an indication of one or more configuration identifiers associated with one or more configurations of the model or the MS that are retained, modified, or released.

Aspect 62: The method of any of Aspects 35-61, wherein a configuration of the model, the MS, or the PS indicates how the network node can activate, deactivate, or switch between models, model structures, or parameter sets.

Aspect 63: An apparatus for wireless communication at a device, comprising a processor; memory coupled with the processor; and instructions stored in the memory and executable by the processor to cause the apparatus to perform the method of one or more of Aspects 1-34.

Aspect 64: A device for wireless communication, comprising a memory and one or more processors coupled to the memory, the one or more processors configured to perform the method of one or more of Aspects 1-34.

Aspect 65: An apparatus for wireless communication, comprising at least one means for performing the method of one or more of Aspects 1-34.

Aspect 66: A non-transitory computer-readable medium storing code for wireless communication, the code comprising instructions executable by a processor to perform the method of one or more of Aspects 1-34.

Aspect 67: A non-transitory computer-readable medium storing a set of instructions for wireless communication, the set of instructions comprising one or more instructions that, when executed by one or more processors of a device, cause the device to perform the method of one or more of Aspects 1-34.

Aspect 68: An apparatus for wireless communication at a device, comprising a processor; memory coupled with the processor; and instructions stored in the memory and executable by the processor to cause the apparatus to perform the method of one or more of Aspects 35-62.

Aspect 69: A device for wireless communication, comprising a memory and one or more processors coupled to the memory, the one or more processors configured to perform the method of one or more of Aspects 35-62.

Aspect 70: An apparatus for wireless communication, comprising at least one means for performing the method of one or more of Aspects 35-62.

Aspect 71: A non-transitory computer-readable medium storing code for wireless communication, the code comprising instructions executable by a processor to perform the method of one or more of Aspects 35-62.

Aspect 72: A non-transitory computer-readable medium storing a set of instructions for wireless communication, the set of instructions comprising one or more instructions that, when executed by one or more processors of a device, cause the device to perform the method of one or more of Aspects 35-62

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, which, individually or in any combination, are operable to cause the UE to:
obtain generalization information associated with a model, a model structure (MS), or a parameter set (PS) associated with the model;
initiate a connection to a network node;
filter the model, the MS, or the PS based at least in part on the generalization information; and
transmit UE capability information to the network node, based at least in part on filtering the model, the MS or the PS, that indicates whether the model, the MS, or the PS is applicable, available, or supported by the UE.

2. The apparatus of claim 1, wherein filtering the model, the MS, or the PS based at least in part on the generalization information comprises filtering the model, the MS, or the PS based at least in part on a scope associated with the model, the MS, or the PS, wherein the scope is indicated in a model structure identifier or a model descriptor associated with the model, the MS, or the PS.

3. The apparatus of claim 1, wherein the one or more processors, to obtain the generalization information, are configured to receive the generalization information from a server, and wherein the one or more processors, to receive the generalization information from the server, are configured to receive a software update from the server that includes the generalization information or to receive the generalization information from the server during a deployment of the model, the MS, or the PS.

4. The apparatus of claim 1, wherein the generalization information includes at least one of area information, location information, network node configuration information, UE configuration information, antenna information, carrier frequency information, band information, sub-carrier spacing information, time division duplexing information, frequency division duplexing information, speed information, range information, Doppler information, or delay spread information.

5. The apparatus of claim 1, wherein the one or more processors are further configured to transmit an indication of model, MS, or PS identifiers that are supported by the UE, wherein the indication is transmitted per cell, per network node, per radio access network area code, per tracking area, or per public land mobile network.

6. The apparatus of claim 1, wherein the one or more processors are further configured to prioritize a filtering of model, MS, or PS identifiers that are supported in a particular cell, network node, radio access network area code, tracking area, or public land mobile network.

7. The apparatus of claim 1, wherein the one or more processors are further configured to refrain from transmitting an indication of a local model, a local MS, or a local PS identifier based at least in part on the UE being configured with a global model, the MS, or the PS.

8. The apparatus of claim 1, wherein the one or more processors are further configured to receive an indication of model, MS, or PS identifiers that are supported by the UE per cell, per network node, per radio access network area code, per tracking area, or per public land mobile network, wherein the indication includes model descriptor information or model assignment information.

9. The apparatus of claim 1, wherein the UE capability information comprises:
model, MS, or PS identifiers that are supported by the UE;
model, MS, or PS identifiers that are available to the UE;
UE vendor information; or
information that indicates whether a model, MS, or PS identifier is cell specific, network node specific, radio access network area code specific, tracking area specific, or public land mobile network specific.

10. The apparatus of claim 1, wherein the one or more processors are further configured to receive, from the network node, a group identifier associated with a plurality of network nodes, wherein the group identifier is used by the UE to identify infra-vendor information or network node grouping information associated with a training of the model, the MS, or the PS.

11. The apparatus of claim 10, wherein the one or more processors are further configured to store a mapping between the group identifier and an infra-vendor identifier and to transmit an indication of a model, MS, or PS identifier that is supported for the network nodes associated with the group identifier.

12. The apparatus of claim 11, wherein the indication of the model, MS, or PS identifier is transmitted per public land mobile network identity list, is transmitted in accordance with a hierarchical structure, or is transmitted with the UE capability information.

13. The apparatus of claim 1, wherein the one or more processors are further configured to receive an indication of a global identifier associated with the model, the MS, or the PS, wherein the global identifier is received in accordance with a hierarchical assignment of the global identifier.

14. The apparatus of claim 13, wherein the one or more processors are further configured to map the global identifier associated with the model, the MS, or the PS to a short identifier associated with the model, the MS or the PS, wherein the mapping of the global identifier to the short identifier is a permanent mapping or is a flexible mapping, and wherein the UE capability information includes an indication of the global identifier or the short identifier.

15. The apparatus of claim 1, wherein a machine learning function, feature, or feature group name, and a model or an MS identifier, is indicated per configuration.

16. The apparatus of claim 1, wherein one or more configurations of the model are retained during a handover operation.

17. The apparatus of claim 1, wherein the one or more processors are further configured to receive, from the network node, an indication of one or more configuration identifiers associated with one or more configurations of the model that are retained, modified, or released.

18. An apparatus for wireless communication at a network node, comprising:
one or more memories; and
one or more processors, coupled to the one or more memories, which, individually or in any combination, are operable to cause the network node to:
obtain generalization information associated with a model, a model structure (MS), or a parameter set (PS) associated with the model;
receive user equipment (UE) capability information associated with a UE;
filter the model, the MS, or the PS based at least in part on the generalization information and the UE capability information; and
transmit an indication, to the UE, that indicates whether the model, the MS, or the PS is to be activated, deactivated, or switched by the UE.

19. The apparatus of claim 18, wherein the one or more processors, to filter the model, the MS, or the PS, are configured to filter model, MS, or PS identifiers associated with the model, the MS, or the PS.

20. The apparatus of claim 18, wherein the one or more processors, to obtain the generalization information, are configured to receive the generalization information from a server, and wherein the one or more processors, to receive the generalization information from the server, are configured to receive the generalization information from the server during a deployment of the model, the MS, or the PS.

21. The apparatus of claim 18, wherein the generalization information includes at least one of area information, location information, network node configuration information, UE configuration information, antenna information, carrier frequency information, band information, sub-carrier spacing information, time division duplexing information, frequency division duplexing information, speed information, range information, doppler information, or delay spread information.

22. The apparatus of claim 18, wherein the one or more processors are further configured to receive an indication of model, MS, or PS identifiers that are supported by the UE, wherein the indication is received per cell, per network node, per radio access network area code, per tracking area, or per public land mobile network.

23. The apparatus of claim 18, wherein the one or more processors are further configured to transmit an indication of model, MS, or PS identifiers that are supported by the UE per cell, per network node, per radio access network area code, per tracking area, or per public land mobile network, wherein the indication includes model, MS, or PS descriptor information or model, MS, or PS assignment information.

24. The apparatus of claim 18, wherein the UE capability information comprises:
model, MS, or PS identifiers that are supported by the UE;
model, MS, or PS identifiers that are available to the UE;
UE vendor information; or
information that indicates whether a model, MS, or PS identifier is cell specific, network node specific, radio access network area code specific, tracking area specific, or public land mobile network specific.

25. The apparatus of claim 18, wherein the one or more processors are further configured to transmit, to the UE, a group identifier associated with a plurality of network nodes.

26. The apparatus of claim 25, wherein the one or more processors are further configured to receive an indication of a model, MS, or PS identifier that is supported for the network nodes associated with the group identifier, wherein the indication of the model, MS, or PS identifier is received per public land mobile network identity list, is received in accordance with a hierarchical structure, or is received with the UE capability information.

27. The apparatus of claim 18, wherein the one or more processors are further configured to transmit an indication of a global identifier associated with the model, the MS, or the PS, wherein the global identifier is transmitted in accordance with a hierarchical assignment of the global identifier.

28. The apparatus of claim 27, wherein the one or more processors are further configured to obtain a short identifier associated with the model, the MS, or the PS that is based at least in part on a mapping of the global identifier to the short identifier, wherein the mapping of the global identifier to the short identifier is a permanent mapping or is a flexible mapping, and wherein the UE capability information includes an indication of the global identifier or the short identifier.

29. A method of wireless communication performed by a user equipment (UE), comprising:
obtaining generalization information associated with a model, a model structure (MS), or a parameter set (PS) associated with the model;
initiating a connection to a network node;
filtering the model, the MS, or the PS based at least in part on the generalization information; and
transmitting UE capability information to the network node, based at least in part on filtering the model, the MS or the PS, that indicates whether the model, the MS, or the PS is applicable, available, or supported by the UE.

30. A method of wireless communication performed by a network node, comprising:
obtaining generalization information associated with a model, a model structure (MS), or a parameter set (PS) associated with the model;
receiving user equipment (UE) capability information associated with a UE;
filtering the model, the MS, or the PS based at least in part on the generalization information and the UE capability information; and
transmitting an indication, to the UE, that indicates whether the model, the MS, or the PS is to be activated, deactivated, or switched by the UE.
